(19) United States
(12) Patent Application Publication
(10) Pub. No.: US 2025/0067871 A1
(43) Pub. Date: Feb. 27, 2025

(54) TRACKING INSTRUMENT WITH RIGID OPTICAL MEASUREMENT UNIT AND COUPLED REFERENCE ELEMENT

(71) Applicant: HEXAGON AICON ETALON GMBH, Braunschweig (DE)

(72) Inventors: Mark WISSMANN, Braunschweig (DE); Johannes BAUTSCH, Braunschweig (DE); Timo KAHLMANN, Salzgitter (DE); Heinrich SCHWENKE, Braunschweig (DE)

(73) Assignee: HEXAGON AICON ETALON GMBH, Braunschweig (DE)

(21) Appl. No.: 18/814,091

(22) Filed: Aug. 23, 2024

(30) Foreign Application Priority Data
Aug. 25, 2023 (EP) 23193540.4

(51) Int. Cl. G01S 17/08; G01S 7/481

(52) U.S. Cl. CPC G01S 17/08; G01S 7/4813; G01S 7/4814; G01S 7/4817; G01S 7/4818

(57) ABSTRACT

A laser tracker for a distance measurement to a target point using a measuring beam. A target axis of the measuring beam can be swivelled around a nodal point inside a revolution body shaped datum fixedly arranged inside a housing of the laser tracker. The laser tracker comprises an optical arrangement providing a measurement path to the target point and an internal reference path. The optical arrangement comprises an optics unit embodied as mechanically fixed arrangement and the laser tracker comprises a force supply arrangement providing a force acting on the optics unit (as a whole) causing the optics unit to maintain contact with the surface of the datum.

### FIELD OF THE INVENTION

The present invention relates to a structure of a high-precision laser tracker configured to determine a distance to a target point using a measuring beam. The laser tracker comprises a revolution body shaped datum fixedly arranged inside a housing of the laser tracker and a target axis of the measuring beam can be swiveled around a fixed nodal point inside the datum.

### BACKGROUND OF THE INVENTION

High precision measurement or tooling machines, such as coordinate measuring machines, vision measuring machines, or articulated robotic arms need to be calibrated to improve their accuracy performance. Such systems are typically built to provide repetitive behavior, but not absolute accuracy. In other words, typical errors of such systems are systematic and can be compensated electronically following a determination. By way of example DE 199 47 374 A1 discloses a calibration method by a tracking instrument. From here on the term laser tracker represent a generic tracking instrument suitable to perform the calibration measurement substantially equivalent to the one disclosed in DE 199 47 374 A1. Said generic laser tracker also comprises the hardware and software components enabling an identification of a tracking target and the alignment of the laser tracker to the tracking target. Tracking targets for the present invention can equally represent cooperative and uncooperative targets.

Since submicrometer precision is required common laser trackers rely on an imaginary fixed point as a datum are ill-suited for this task. E.g. for a typical gimbal mounting a perfect datum requires that the two axes of rotation to be aligned such that they intersect at a point which also lies on the plane of the beam steering mirror. Moreover, the laser beam have to be aligned with said intersection point. All of these alignments should be performed with submicrometer accuracy, which is tedious, when not outright impossible.

As an alternative, laser trackers based on a datum following are developed, as disclosed e.g. in EP 0 919 830 A2, EP 1 959 226 A2, or in DE 20 2004 007 647 U1. Such systems are based on measuring the distance, particularly based on interferometric principles, from a physical datum embodied as a reflective sphere. To ensure the positional and thermal stability the mobile components of the laser tracker are decoupled from the datum. The mobile components are closely following the surface of the datum. Due to the existence of a physical datum small displacements of said components, i.e. the interferometer, have no influence on the measurement precision. The precision, ideally, only depends on the manufacturing tolerances of the physical datum which can be in the range of few tens of nanometers.

One drawback of the described construct is the fact that the physical datum acts as an optical reference surface. This requires complex optics and very tight mechanical tolerances to keep the wavefront of the interferometer, i.e. the signal quality, high. Moreover, the mobile elements of the laser tracker needs to be mechanically decoupled from the physical datum, which necessitates high accuracy steering mechanisms and control to follow the datum surface with a precision of <5 μm, but in a non-touching manner.

Systems wherein the two functionalities of the physical datum, i.e. the mechanical datum and the optical reference surface, are realized by two separate components are thus desirable as they could provide similar precision with simplified mechanical and optical constructs.

### OBJECT OF THE INVENTION

In view of the above circumstances, an object of the present invention is to provide a laser tracker with simplified construct, while improving or maintaining the measurement precision.

Another objective of the present invention is to decouple the optical reference surface from the mechanical datum.

Another objective of the present invention is to prevent or at least reduce the influence of mechanical deformations on the precision.

These objectives are at least partly achieved by realizing the characterizing features of the independent claims. Features, which further develop the invention in an alternative or advantageous manner are described in the dependent patent claims.

### SUMMARY OF THE INVENTION

The present invention relates to a laser tracker for a distance measurement to a target point using a measuring beam. The laser tracker comprises a revolution body shaped datum fixedly arranged inside a housing of the laser tracker. A target axis of the measuring beam can be swiveled around a fixed nodal point inside the datum. By way of example from here on laser, as a specific embodiment, will be used interchangeably with measuring beam. The specific features of other types of optical measuring beams might be applied accordingly.

The inventive laser tracker belongs to the group of high-precision tracking instruments. In particular, the laser tracker provides distance data with better than 1 μm precision. Contemporary laser trackers realize this precision on the basis of interferometric or time of flight measurements. By way of example many features of the inventive laser tracker will be disclosed in combination with interferometric measurements. This, nevertheless, shall not be construed in a limiting fashion. The skilled person understands that the inventive aspects are applicable in combination with many different types of tracking instruments. The specific features of tracking instruments operating on different distance measuring principles, e.g. pulse time of flight, or frequency-modulated continuous mode lidar, might be applied accordingly.

The laser tracker comprises an optical arrangement configured to provide a measurement path of the measuring beam to the target point and an internal reference path. The optical arrangement comprises an optics unit and a fiber connected to a source of the measuring beam. The optics unit comprises, (i) a feed-in point for the fiber, (ii) a beam exit for emitting the measuring beam along the target axis, (iii) a contacting surface configured to contact a tangential point on a surface of the datum. The skilled person understands that, unless the contrary is expressly provided, the above and any further numbering serves readability purpose only and does not represent a specific spatial order or temporal sequence. Reasonable variations of component geometries or sequences to perform methodical steps are within the sense of the present invention.

The optics unit is embodied as mechanically fixed arrangement. I.e. the optics unit, under the expected forces and torques, can be approximated by a rigid body. The optics unit does not comprise any mechanical intervention options that would allow a user of the laser tracker to actively interfere with the mechanical arrangement of the optics unit to alter the optical path length between the feed-in point and the beam exit. The optics unit also does not comprise any movable component that is intended to alter the optical path length between the feed-in point and the beam exit during operation of the laser tracker. In other words (from possibly unavoidable but negligible thermal expansion aside) the optical path between the feed-in point and the beam exit is invariant. Invariant in the sense of the invention means that the optical path does not change during a measurement operation due to a pose change of the optics unit or the tracker as a whole. The optics unit might comprise beam deflection and beam shaping elements configured to provide said optical path. The section of the measuring beam inside the optics unit can be especially realized as a free-beam, while the beam deflection and beam shaping elements can comprise high-reflectivity mirrors, semi-transparent mirrors, collimating and focusing lenses. The optics unit might be realized without polarization splitters or waveplates. While one aspect of the present invention relates to enabling simplified optics units, nevertheless the present invention is applicable with many reasonable embodiments of the optics unit. Some embodiments are known from the state of the art and the skilled person is competent to select a suitable one.

The contacting surface is configured to touch the datum, thereby constraining the movement of the optics unit. In other words, the pose of the various components of the optics unit are precisely defined, in particular comparably to datum itself. In the sense of the present invention further optical components located at least partly outside the housing of the laser tracker, e.g. light guides, laser sources etc., are not considered to be part of the optics unit, but they may be part of the optical arrangement as a whole.

The laser tracker is configured to use the surface of the datum as a mechanical guide for a movement of the optics unit about the nodal point. The laser tracker comprises a force supply arrangement configured to provide a force acting on the optics unit (as a whole). The force acting on the optics unit causes the optics unit to maintain contact with the surface of the datum via the tangential points of the surface of the datum.

In other words, the datum defines the optical reference surface. The datum can define the optical reference directly or indirectly, in particular by enabling a controlled movement of an optical reference element whose pose is invariably defined with respect to the datum. The advantage of the indirect definition is the possibility to utilize a further element, e.g. an optical flat or an end face of the fiber, to act as optical reference. This allows a simpler design of the optics unit as well as less stringent requirements on the individual components. Moreover, by decoupling the mechanical and optical reference surfaces the optical properties of the datum become irrelevant. By way of example only the indirect definition of the optical reference surface will be discussed in details.

In some embodiments, the datum is spherical and the nodal point is the center of mass of the spherical datum. Due to the precision requirements sphere is to be understood in a strict manner. In particular the datum possess an ISO-21920-2:2021 RMS surface roughness below 20 nm and form deviations below 200 nm. In other words the mechanical datum can be foreseen as a perfect sphere, and the optics unit is configured to move along the surface of this sphere.

In some embodiments, the force provided by the force supply arrangement is constant in time and independent of the pose of the optics unit. In other words, the weight of the optics units and the components driving it about the datum plays no role in setting the contact force. Moreover, in some embodiments, said force is negligible with regard to the compliance of the mechanical datum and its mounting.

In some embodiments, the contacting surface is embodied as a wear-free diamond surface, particularly a wear-free diamond plate.

In some embodiments, the force supply arrangement comprises a spring, in particular a pre-tensioned coil spring. The spring is configured to generate a spring force acting on the optics unit and causing the optics unit to maintain contact with the surface of the datum.

In some specific embodiments, the force supply arrangement is provided by a spring-pair mounted such that the lines of action of the springs of the spring pair are parallel to the target axis and the target axis is located between the lines of action. Such embodiments are advantageous since balancing the tangential components and/or moments of the spring forces is less challenging with a plurality of springs. Other geometries comprising three or more springs are also possible in the sense of the present invention.

In some embodiments, the laser tracker is configured to provide magnetic attraction between the optics unit and the datum to maintain the contact with the surface of the datum. Magnet-based contacting is advantageous, because no external force is applied to the datum apart from friction and gravity forces. In other words, the datum and the optics unit can be realized as a system mechanically decoupled from environment and/or the further components of the laser tracker. Magnet-based contacting is also advantageous as magnetic forces can be precisely controlled, unlike to the spring force which might drift due to the wear and tear of the spring.

In some specific embodiments, the force supply arrangement is provided by a magnetic element arranged at the optics unit, particularly at or in the vicinity of the contacting surface, more particularly next to a contacting point on the contacting surface for contacting the tangential point. The datum is configured to be magnetically attractable. More specifically, the magnetic is element embodied as a permanent magnet or an electromagnet and the datum comprises or is made from ferromagnetic material. Permanent magnet based magnetic elements are advantageous as they require no power lines, i.e. wiring which might exert force on the carriage during the movement of the optics unit. Electromagnets on the other hand may allow an electronic control of the force between the contacting surface and the tangential point.

In some specific embodiments, the force supply arrangement comprises at least one guide allowing a uniaxial translation of the optics unit. In particular the direction of the uniaxial translation is parallel to the target axis. I.e. a displacement of the target axis is prevented by preventing a rotation of the optics unit.

In some specific embodiments, the magnetic element is mounted with its pole axis parallel to the target axis. Alternatively or additionally, the force supply arrangement comprises or provided by a pair of magnetic elements mounted such that the target axis is located symmetrically between the pole axes of the magnetic elements.

In some embodiments, the laser tracker comprises a suspension arrangement for force-free suspension of the optics unit. In particular the suspension arrangement is configured to support the weight of the optics unit such that a gravity-induced interaction between the contacting surface and the surface of the datum is minimized, in particular prevented, in each relative pose of the optics unit relative to the surface of the datum. These embodiments allow an improved precision in spite of the direct mechanical contact between the datum and the optics unit, as the force applied to the datum is reduced exclusively to a friction of the swivel bearing, regardless of the angle or installation position of the overall system. In other words, these embodiments enable simpler design with larger tolerances of the interferometer and the mechanics.

In some embodiments, the suspension arrangement comprises a tilt axis piercing a center of mass of optics unit and thereby allow a force-free tilting of the optics unit about the tilt axis. The tilt axis might be horizontal i.e. parallel to a defined plane of the laser tracker. In other words, for correctly justified poses of the laser tracker, the tilt axis is perpendicular to the direction of gravity. The tilt axis might be foreseen as a continuous single-piece physical axis, but can also be an imaginary rotation axis, e.g. provided by a suspension arrangement providing multiple degrees of freedom for the movement of the optics unit.

In some specific embodiments, the tilt axis is perpendicular to and offset from the target axis, and the tilt axis and the tangential point define a plane tangential to the surface of the datum. In alternative wording, for any position of the optics unit relative to the datum, the center of mass of the optics unit and the tangential point (to be contacted by the contacting surface of the optics unit during operation) are lying on a line tangential to the surface of the datum. Consequently, the optics unit can only exert force on the datum along the latter's normal.

In some specific embodiments, the suspension arrangement comprises a swivel or rotary bearing, in particular embodied as low friction ball- or roller bearing, to provide or mount the tilt axis.

In some specific embodiments, the optics unit comprises at least one counterweight mounted in such a way as to ensure that tilt axis pierces the center of mass of optics unit, in particular wherein the counterweight is mounted in an adjustable manner. Due to the high precision requirements adjustable in the sense of the invention means “factory adjustable”, i.e. the pose or the weight of the counterweight might be adjustable during a rare calibration event and not during the everyday use of the laser tracker.

In some embodiments, the laser tracker is configured to perform the distance measurement based on interferometric principles. In particular the laser tracker is configured to provide the distance measurement to the target point with submicrometer precision. While the inventive laser tracker, in principle, is compatible with non- or partly interferometric methods such as frequency modulated continuous wave lidar, interferometry measurements represents an overall adequate compromise between accuracy and size/weight of the optical arrangement.

In some specific embodiments, the fiber is embodied as a non-polarizing single mode fiber and the feed-in point provides an optical reference point for the internal reference path. The distance to the target point might also be measured from the feed-in point. Such interferometric designs are known from the prior art. In some specific embodiments, a distal end of the fiber located outside the housing and optically coupled to a fiber splitter. Having a laser source outside the housing of the laser tracker is advantageous due to the constrained space and from thermal management point of view. Design elements configured to minimize the inaccuracy caused by the force exerted by the fiber connected to an outside point are also known from the prior art.

In some embodiments, the optics unit comprises a first part having a first thermal expansion coefficient and a second part having a second thermal expansion coefficient. The first thermal expansion coefficient is less than 10⁻⁵K⁻¹, in particular less than 10⁻⁶ K⁻¹. The second thermal expansion coefficient correlates with the thermal expansion coefficient of the datum. The second part is dimensioned such that its thermal expansion compensates the thermal expansion of the datum. In other words, the first part is made of an invar alloy. Due to machining requirements, the datum itself cannot be made of such alloys, thus an insert of the optics units is configured to compensate a thermal expansion of the datum as well as changes of the refractive indices due to thermal effects.

In some embodiments, the laser tracker comprises a base plate. The base plate has a fixed spatial relationship with the datum and is configured to define an orientation of the laser tracker with respect to an external coordinate system. The housing is rotatable relative to the base plate.

In some specific embodiments, the laser tracker comprises a support unit supporting the optics unit. The support unit is mounted to the base plate rotatably. The housing is mounted to the support unit. The thermal expansion coefficients of the base plate and the support unit are selected to minimize the thermal movement of the reference point in regard to the base plate.

In some specific embodiments, the housing is configured to enclose the datum and the optics unit in a dust—and humidity protected manner. The housing comprises a fixed exit window transparent for the measuring beam, such that for the distance measurement to the target point, the measuring beam exits at the beam exit of the optics unit and then passes the exit window. In some particular embodiments, the exit window is of cylindrical shape and has an extent of at least 50°, in particular at least 80°, in direction perpendicular to the plane of base plate. Large exit windows are advantageous as they enable a design, wherein the exit window is built in the housing with a fixed inclination. This embodiment offers many beneficial properties (i) the housing can be realized as a hard case offering better mechanical properties, (ii) due to the lack of moving components the sealing can realized in a more reliable manner, and (iii) the drive apparatus of the exit window and/or a direct mechanical coupling between the optics unit and the exit window can be omitted which eliminates one possible source of inaccuracy for the measurement. Latter is especially advantageous, as unlike to the prior art, the optics unit and the datum are in mechanical contact with each other.

The exit window might be formed from chemically strengthened silicate-based glass or from sapphire-based material.

While contemporary manufacturing techniques do not enable to produce the exit window with the required homogeneity, such measurement errors, due to the fixed geometry can be characterized and stored in a look-up-table for compensation. In other words, improved accuracy can be realized by straightforward means.

In some specific embodiments, the laser tracker comprises a handle with fixed spatial relationship to the base plate. The laser tracker is configured to provide a transport mode. In the transport mode a rotation of the housing is locked, and the exit window is positioned between the datum and the handle. In some particular embodiments, the exit window is automatically positioned to the opposite side of the handle during a startup sequence. In some specific embodiments, the handle is dismountable to allow a full, 360° measurement of the azimuth axis.

In some specific embodiments, the base plate comprises three pads protruding from the base plate on the side opposite to the datum and providing a three-point support for the baseplate. The pads define the plane of the base plate. The pads might be realized as fixed or leveling feet. The base plate comprises a plurality of drill holes. The drill holes are configured to accommodate fastening elements providing a mechanical coupling to an external object, in particular bolts connected to corresponding sliding blocks. The plurality of drill holes comprise a first and a second group. Each of the drill holes of the first group of drill holes is located within one of the three pads. The second group of drill holes comprises at least one drill hole outside the three pads. For the skilled person it is clear that drill holes represent generic class of features configured to accommodate said fastening elements and different types of closed or open recesses are drill holes in the sense of the invention.

In some specific embodiments, a plane defined by a first drill hole from the first group, a second drill hole from the second group and the nodal point is perpendicular to the plane of the base plate. In other words, the first and the second drill holes are laying on a line which intersects a projection of the nodal point to the base plane. The first and the second drill holes might be equidistant from the nodal point.

In some specific embodiments, the drill holes of the first group, and in particular at least one drill hole of the second group, are arranged equidistantly from the nodal point. In particular, wherein the pads are arranged to an equilateral triangle.

In some specific embodiments, the second group comprises a plurality of drill holes, in particular two. More particularly, the drill holes of the second group are arranged such that each drill hole of the second group is associated with a respective drill hole of the first group and the plane defined by said two drill holes and the nodal point is perpendicular to the plane of the base plate.

For example, the base plate comprises for each of the pads a drill hole of the second group in an opposing position. The drill holes of the first and second group might be located on the perimeter of the base plate in a regular hexagonal arrangement. Alternatively, the handle might be arranged in a position opposing one of the pads and the base plate comprises two drill holes of the second group in a position opposing the further pads.

In some specific embodiments, one of the drill holes of the first group and one of the drill holes of the second group provides a fastening axis and the base plate has reflection symmetry with respect to the fastening axis.

The invention further relates—on its own or in combination with any of the features described above—to a laser tracker, wherein a target axis of a measuring beam can be swiveled around a fixed nodal point inside a revolution body shaped datum. The datum is fixedly arranged inside a housing of the laser tracker. The laser tracker comprises an optical arrangement configured to provide a measurement path of the measuring beam to the target point and an internal reference path. The optical arrangement comprises an optics unit and a fiber connected to a source of the measuring beam. The optics unit comprises (i) a feed-in point for the fiber, (ii) a beam exit for emitting the measuring beam along the target axis. The laser tracker is configured to use the surface of the datum as a mechanical guide for a movement of the optics unit about the nodal point. The optics unit might comprise a reference point on the surface of the datum. The laser tracker comprises base plate. The base plate has a fixed spatial relationship with the datum and is configured to define an orientation of the laser tracker with respect to an external coordinate system. The housing is rotatable relative to the base plate. The base plate comprises (i) three pads protruding from the base plate on the side opposite of the datum and providing a three-point support for the base plate, (ii) a plurality of drill holes configured to accommodate fastening elements providing a mechanical coupling to an external object, in particular bolts connected to corresponding sliding blocks. The plurality of drill holes comprise a first and a second group. Each of the drill holes of the first group of drill holes is located within one of the three pads. The second group of drill holes comprises at least one drill hole outside the three pads.

The invention also relates—on its own or in combination with any of the features described above—to a laser tracker, wherein a target axis of a measuring beam can be swiveled around a fixed nodal point inside a revolution body shaped datum. The datum is fixedly arranged inside a housing of the laser tracker. The laser tracker comprises an optical arrangement configured to provide a measurement path of the measuring beam to the target point and an internal reference path. The optical arrangement comprises an optics unit and a fiber connected to a source of the measuring beam. The optics unit comprises (i) a feed-in point for the fiber, (ii) a beam exit for emitting the measuring beam along the target axis. The laser tracker is configured to use the surface of the datum as a mechanical guide for a movement of the optics unit about the nodal point. The optics unit might comprise a reference point on the surface of the datum. The laser tracker comprises base plate. The base plate has a fixed spatial relationship with the datum and is configured to define an orientation of the laser tracker with respect to an external coordinate system. The housing (i) is rotatable relative to the base plate, (ii) is configured to enclose the datum and the optics unit in a dust—and humidity protecting manner, and (iii) comprises a fixed exit window transparent for the measuring beam, such that for the distance measurement to the target point, the measuring beam exits at the beam exit of the optics unit and then passes the exit window.

In some embodiments the laser tracker comprises a handle with fixed spatial relationship to the base plate. The laser tracker is configured to provide a transport mode. In the transport mode a rotation of the housing is locked, and the exit window is positioned between the datum and the handle. In some particular embodiments, the exit window is automatically positioned to the opposite side of the handle during a startup sequence. In some specific embodiments, the handle is dismountable.

### BRIEF DESCRIPTION OF THE DRAWINGS

By way of example only, specific embodiments of the invention will be described more fully hereinafter with reference to the accompanying figures, wherein:

FIG. 1a depicts the schematics of a prior art laser tracker.

FIG. 1b illustrates an optical arrangement, and particularly the interferometer known from the prior art.

FIG. 2a depicts the schematics of an embodiment of the inventive laser tracker comprising a spring-pair as force setting elements.

FIG. 2b shows a schematic description of an optical arrangement of the laser tracker depicted in FIG. 2a.

FIG. 3 depicts the schematics of an embodiment of the inventive laser tracker comprising a magnet as force setting elements.

FIG. 4 depicts the schematics of an embodiment of the inventive laser tracker with a suspension arrangement for force-free suspension of the optics unit.

FIG. 5 depicts the schematics of an embodiment with large field of view fixed exit window.

FIG. 6a depicts the base plate with pads and drill holes as viewed from the bottom.

FIG. 6b depicts a step of mounting the base plate to an external object having a surface with grooves enabling the positioning of sliding blocks.

FIG. 6c depicts an alternative mounting situation.

### SPECIFIC EMBODIMENTS OF THE INVENTION

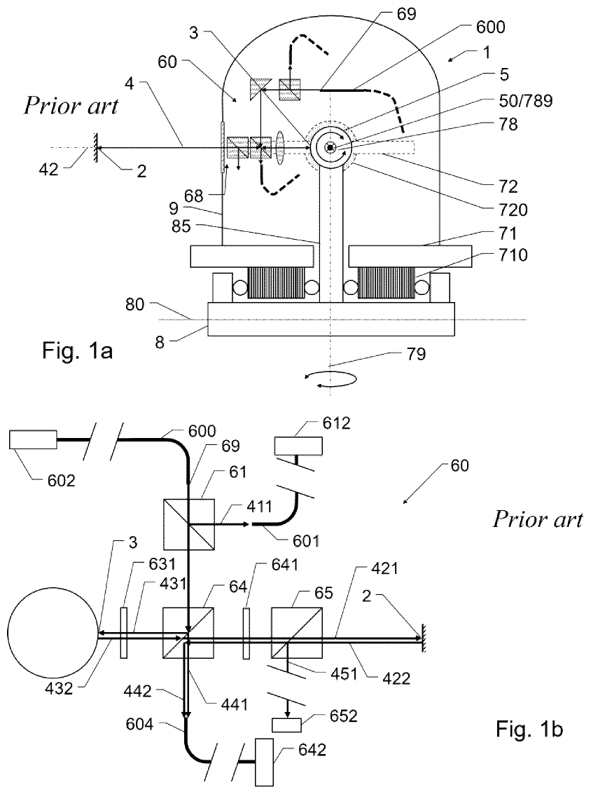

FIG. 1a shows schematically a prior art laser tracker 1. The laser tracker 1 is configured to determine distance between a target point 2 and an optical reference point 3. The target point 2, in some embodiments, is a specially designed retroreflector. The laser tracker 1 is configured to track a movement of the target point 2. Various tracking methods are known from the prior art, and the skilled person can provide a suitable tracking method. The present invention is not limited to any specific tracking methods known, in particular the present invention is applicable to refinements, enhancement of said or suitable alternative methods. The optical reference point 3, in the depicted embodiment, is on the surface of a mechanical datum 5. The datum 5 is mounted to a base plate 8 in a rigid manner by a shaft 85. The base plate 8 is configured to define a relative orientation of the laser tracker 1 with respect to an external coordinate system, in particular to define a plane 80 of the base plate 8.

To determine the distance between the target point 2 and the optical reference point 3 the laser tracker 1 comprises an optical arrangement 60. The optical arrangement 60 comprises a fiber 600, and an interferometer. A distal end of the fiber 600, coupled to a laser source, which might be located outside the housing 9 of the laser tracker 1. The components of the optical arrangement 60 located inside housing 9 of the laser tracker 1 and configured to move substantially together can be regarded as an equivalent of the optics unit.

The interferometer comprises a feed-in point 69 for the fiber 600 and a beam exit 68 for emitting the measuring beam 4 along the target axis 42. The interferometer transmits the measuring beam 4, and defines a section of the optical path inside the interferometer of the laser tracker 1. Some key features of the depicted interferometer are shown in more details in FIG. 1b.

The laser tracker 1 also comprises a carriage configured to align the optical arrangement 60 such that a target axis 42, corresponding to a section of a measuring beam path outside of the housing 9, intersects the target point 2 and a nodal point 50 of the datum 5. In other words, the carriage is configured to rotate a part of the optical arrangement 60 about the nodal point 50 in the datum 5.

By way of example the carriage comprises a support unit 71 mounted to the base plate 8 and a first motor 710, e.g. a direct-drive do servo motor, to rotate the support unit 71 about a first axis of rotation 79. The first axis of rotation 79 coincides with the shaft 85 of the datum 5. The carriage also comprises a yoke 72 and a second motor 720 to tilt the yoke 72 about a second axis of rotation 78 perpendicular to the first axis of rotation 79. The intersection 789 of the first 79 and the second axes of rotation 78 coincides, within the required accuracy, with the nodal point 50. While the interferometric measurement principle is tolerant to small lateral offsets of the interferometer, nevertheless μm range accuracy is required from the components 71, 72,710,720 of the carriage. Many alternatives of the depicted prior art carriage exists and the applicability of the present invention is not limited to a specific variant.

FIG. 1b illustrates an embodiment of the optical arrangement 60, and particularly the interferometer known from the prior art. The interferometer is a moving together with the carriage. For this reason, the laser source 602 cannot be fed directly to the interferometer, so a polarisation-maintaining fiber 600 is used to launch the two orthogonal polarisations into the interferometer at the feed-in point 69. Disturbances of the polarisation maintaining fiber 600 e.g. due to thermal drift or mechanical motion will induce mixing of the two orthogonal polarisations within the fiber 600. To prevent this mixing from affecting the accuracy of the displacement measurement, a reference counter signal 411 is extracted al the interferometer by a first beam-splitter 61. In this way, the effect of polarisation mixing is common to the reference counter signal and to the measurement counter signal and are thus eliminated. This signal is fed via an optical fiber 601 to the reference count input 612 on the counter card.

A polarising beam-splitter 64 separates the two orthogonal polarisations. One goes straight through as a reference 441. The second 431 is sent via a quarter-wave plate 631 to the optical reference point 3 and back 432 through the quarter-wave plate 631 to the polarising beam-splitter 63. Each pass through the quarter-wave plate 631 rotates the polarisation state of the beams 431,432 through 45°. The targeting beam 421 then passes through the polarising beam-splitter 64 and a second quarter-wave plate 641 to the target point 2. The target 2 retro-reflects a return beam 422 back through the quarter-wave plate 641 which ensure that on hitting polarising beam-splitter 64, the measuring beam 442 is reflected out to interfere with the reference beam 441. The measurement signal produced by this interference is transmitted via optical fiber 604 to the measurement count input 642 on the counter card. A third beam-splitter 65 is used to direct a fraction 451 of the return beam 422 from the target 2 to a position-sensitive detector 652 which provides position feedback for the tracking servo. For transparency reasons, collimating, focusing and further beam shaping elements are not shown. The skilled person can provide such elements based on the prior art.

As can be seen the prior art system requires a rather complex optical arrangement 60 due to the requirements of the moving interferometer and due to the mechanical datum directly providing the optical reference point 3. The latter also necessitates that the mechanical datum shall possess a surfaces which can provide the optical reference point 3.

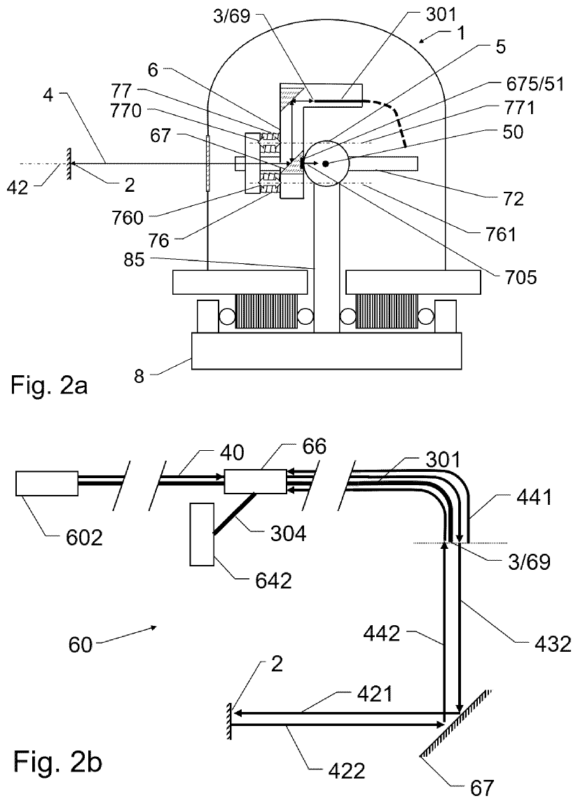

FIG. 2a illustrates the schematics of a first embodiment of the inventive laser tracker 1. In the depicted realization of the inventive concept the mechanical datum 5 does not provide the optical reference point 3 directly. The optical reference point 3, depicted as the feed-in point 69 of a non-polarizing single mode fiber 301, performs a defined, i.e. constrained movement along a surface. The nodal point 50 of said surface and the center point of the datum 5 coincide. The optical arrangement comprises a mechanically fixed optics unit 6, i.e. its internal components, including the feed-in point 69, possess defined spatial relationship to each other. The depicted optics unit 6 is mounted on the yoke 72 such that its pose is defined by the pose of the yoke 72. The yoke 72, as in FIG. 1a, is part of the carriage aligning the optics unit 6 such that the measuring beam 4 is hitting and reflected back from the target point 2.

The optics unit 6 comprises contacting surface 675, in particular a wear-free diamond plate, configured to contact a tangential point 51 on a surface of the datum 5. This contact ensures a defined spatial relationship between the optical reference point 3 and the datum 5. A high-reflectivity mirror 67 configured to deflect the measuring beam 4 is mounted together with the contacting surface 675.

The laser tracker 1 comprises a force supply arrangement, embodied as a spring-pair 76,77 configured to provide a contact force 705, i.e. a net force arising from the spring forces 760,770, between the contacting surface 675 and the datum 5. The spring-pair 76,77 is mounted such that their lines of action 761,771 is parallel to the target axis 42 and the target axis 42 is located between the respective lines of action 761,771. While a spring-pair 76,77 represents a good compromise between the complexity and weight of the force providing element and the balancing of the tangential components of the contact force 705 the present invention can be realized by other spring geometries.

The contact force 705 is set such that it causes no substantial deformation or displacement of the mechanical datum 5. In other words spring-pair 76,77 is configured to provide a spring force 760,770 which is negligible in regard to the compliances of the datum 5, the shaft 85 or the base 8. To achieve a required precision in the submicrometer range the contact force 705, i.e. the spring forces 760,770 cannot exceed 100 mN, preferably 10 mN.

FIG. 2b shows a schematic description of an optical arrangement 60 of the laser tracker depicted in FIG. 2a. Since the datum is not an optical component the requirements for the wavefront quality are significantly reduced. This enables a much simpler interferometer as compared to the design of FIG. 1b. The laser light 40 from a stabilized laser source 602 is fed to a fiber splitter 66 connected to the non-polarising single mode fiber 301. The feed-in point 69, which is located in the housing of the laser tracker and has fixed spatial relationship with the further components of the interferometer, reflects back a part of the laser light to the fiber 301. The reflected laser light acts as reference light 441, while the feed-in point 69 acts as optical reference point 3.

The light emanating 432 from reference point 3 is deflected by the respective beam deflection element, e.g. a high reflectivity mirror 67, towards the target 2. The target 2 reflects the transmitted beam 421 back towards the mirror 67. The return beam 422 is deflected towards the optical reference point 3 by the mirror 67. The measuring beam 442 enters the fiber 301 and interferes with the reference beam 441. The measurement signal produced by this interference is decoupled by the fiber splitter 66 and transmitted via optical fiber 304 to the measurement count input 642 on the counter card.

Said design is not only advantageous from complexity and cost point of view, but also for measurement accuracy. The interferometer is mobile component rotating about the datum. i.e. its weight and a deformations arising from this weight are important source of systematic errors, i.e. reduced weight is desirable for generic laser trackers.

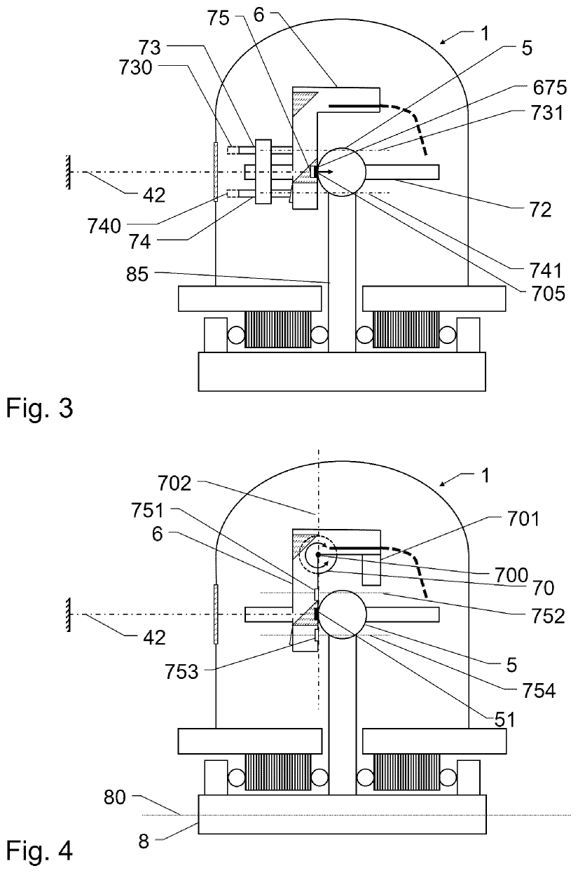

FIG. 3 shows a second embodiment of the inventive laser tracker 1. The key difference between the second embodiment and the first embodiment depicted in FIG. 2a is that the contact force 705 between the datum 5 and contacting surface 675 is provided by a magnetic element 75, depicted as a permanent magnet, mounted on the contacting surface 675 on the side opposite of the side in contact with the datum 5. Advantageously, magnetic attraction between the datum 5 and magnetic element 75 can be understood as purely internal force, i.e. no anchoring to a further component is needed. The datum 5 is made of or comprises ferromagnetic materials. The skilled person understands that variations on the number, the placement or the working principle of the magnetic element 75 are within the sense of the present invention. E.g. instead of a single permanent magnet a pair or trio electromagnets might be equally used.

The optics unit 6 is mounted to the carriage, represented by the yoke 72, such that a pair of guides 73,74 and respective channels 730,740 allowing an uniaxial translation of the optics unit 6. The magnetic element 75 is located between the axes 731,741 of the channels 730,740. The axes 731,741 of the channels 730,740 are parallel with the target axis 42. This geometry compensates the tangential components of the contact force 705.

FIG. 4 shows a third embodiment of the inventive laser tracker 1. The key difference between the third embodiment and the second embodiment, depicted in FIG. 3, is that the laser tracker 1 comprises suspension arrangement 70 for force-free suspension of the optics unit 6. The suspension arrangement 70 is configured to support the weight of the optics unit 6 such that a gravity-induced interaction between the contacting surface 675 and the surface of the datum 5 is prevented in each relative pose of the optics unit 6 relative to the surface of the datum 5.

In the depicted embodiment the suspension arrangement 70 comprises a tilt axis 700 piercing a center of mass of optics unit 6. By way of example the tilt axis 700 is horizontal. Horizontal in the sense of the present invention can be understood as parallel to the plane 80 of the base plate 8. In other words, for correctly justified poses of the laser tracker 1, the depicted tilt axis 700 is perpendicular to the direction of gravity. The tilt axis 700 might be realized as a continuous, single-piece physical axis, but can also be realized as an imaginary rotation axis. The depicted tilt axis 700 is perpendicular to and offset from the target axis 42. The tilt axis 700 and the tangential point 51 define a plane 702 tangential to the surface of the datum 5. The optics unit 6 comprises a counterweight 701 mounted in such a way to ensure that tilt axis 700 pierces the center of mass of optics unit 6. The suspension arrangement 70 also provides the functionality of the guides of the second embodiment, therefore they are not necessary in this embodiment.

In the depicted embodiment the force supply arrangement is provided by a pair of magnetic elements 751,753 mounted such that the target axis 42 is located between the pole axes 752,754 of the magnetic elements 751,753.

It is clear for the skilled person that the depicted first, second and third embodiments are focused on showing some specific features of the inventive laser tracker. The individual features of these embodiments might be combinable with each other and/or replaced by suitable alternative features, or some of the optional features might be omitted completely.

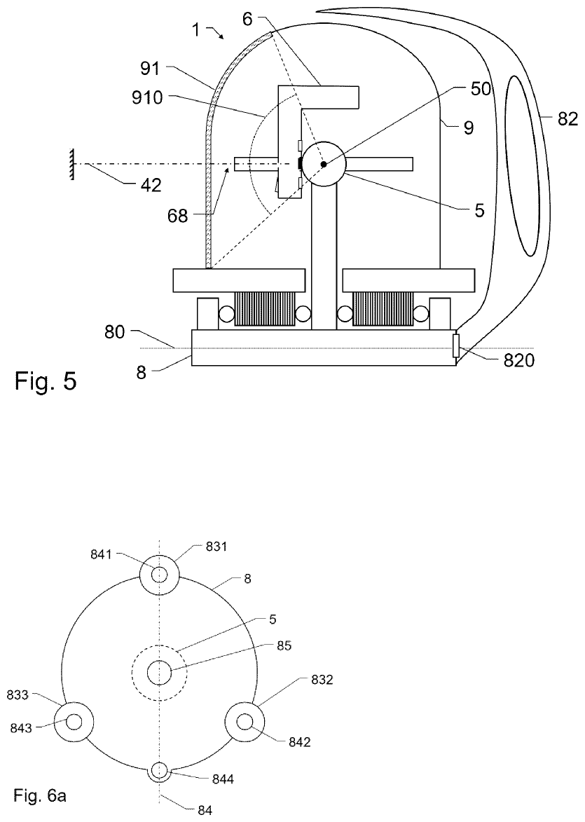

FIG. 5 shows an embodiment, wherein the housing 9 comprises a fixed exit window 91, such that for the distance measurement to the target point, the measuring beam along the target axis 42 exits at the beam exit 68 of the optics unit 6 and then passes the exit window 91. The exit window 91 provides an inclination field of view 910 of at least 50°, in particular at least 80°, as view from the nodal point 50. Inclination means perpendicular to the plane 80 of base plate 8.

This design offers many advantages as compared to the prior art with small, movable exit windows 91. Fixed exit windows 91 do not requires e.g. bellows, thus the housing 9 can be realized as a fully-enclosing hard case, which offers better safety as well as environmental sealing. Moreover, separate motors, synchronized with the optics unit 6, or direct mechanical coupling between the optics unit 6 and the exit window 91 can also be omitted, which enables a more precise design of the laser tracker 1.

The depicted embodiment also comprises a handle 82 with fixed spatial relationship to the base plate 8. The depicted handle 82 comprises a mounting element 820 allowing a quick mounting/demounting of the handle 82 from the base plate 8. The laser tracker 1, as depicted, is in an operation mode, i.e. the exit window 91 and the handle 82 are located on the opposite sides of the datum 5. The laser tracker 1 is configured to provide a transport mode, wherein a rotation of the housing 9 is locked, and the exit window 91 is positioned between the datum 5 and the handle 82. The handle 82 covering the exit window 91 and provides a shielding against blow damage.

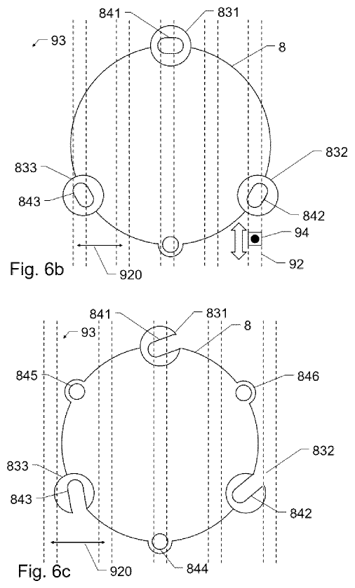

FIG. 6a shows a schematic depiction of a base plate 8 according to the invention. The base plate 8 has three pads 831-833 protruding from the base plate 8 arranged near the perimeter of the base plate 8. In the depicted embodiment the pads 831-833 are arranged in an equilateral triangular arrangement. The pads 831-833 define the plane of the base plate 8. The pads 831-833 also have respective drill holes of the first group 841-843 configured to accommodate fastening elements providing a mechanical coupling to an external object. The fastening elements might be bolts connected to respective sliding blocks. By way of example the drill holes 841-843 are embodied as circular holes.

Due to the geometry of the external object three-point fixing is not always feasible. The base plate 8 therefore has a drill hole of the second group 844 spaced from the drill holes of the first group 841-843. In this particular embodiment the drill hole of the second group 844 is arranged such one of the drill holes of the first group, i.e. drill hole 841, and the drill hole of the second group 844 provides a fastening axis 84. The base plate 8 has reflection symmetry with respect to the fastening axis 84. This allows a two point fastening of the base plate 8, with its fastening axis 84 located between the further two pads 832,833 i.e. a three-point support using the pads 831-833 is possible. In the depicted embodiment the fastening line 84 intersects the shaft 85 of the datum 5, or in other words, a projection of the datum 5 to the base plane 8. The second group might comprise further drill holes.

FIG. 6b depicts a step of mounting the base plate 8 (with the laser tracker) to an external object 93 having a surface with grooves 92 enabling the positioning of sliding blocks 94. The first group of drill holes 841-843 associated with the pads 831-833 are realized as elongated holes. The distance 920 of the grooves 92 is such that a three point fastening using the first group of drill holes 841-843 is possible.

FIG. 6c depicts an alternative mounting situation. Here, due to the distance 920 of the grooves 92 on the external object 93, a three-point mounting using the first group of drill holes 841-843 located inside the pads 831-833 is not possible. Contrary to that, a two-point mounting based on one drill hole of the first group 841-843, here hole 841, and one drill hole of the second group 844-846, here hole 844, is always possible, as two points can be aligned to a line. Since the selected first 841 and second holes 844 are in between the two further pads 832,833, a three-point support based on the three pads 831-833 can also be realized. By way of example the first group of drill holes 841-843 are depicted as semi-open recesses and the second group of drill holes 844-846 are depicted as cylindrical holes. The skilled person understands that there are many suitable alternatives, thus that neither the depicted placement nor the shape of the drill holes 841-846 are to be construed in a limiting manner.

Although the invention is illustrated above, partly with reference to some specific embodiments, it must be understood that numerous modifications and combinations of different features of the embodiments can be made. All of these modifications lie within the scope of the appended claims.

1. A laser tracker for a distance measurement to a target point using a measuring beam, wherein:
a target axis of the measuring beam can be swiveled around a fixed nodal point inside a revolution body shaped datum fixedly arranged inside a housing of the laser tracker,
the laser tracker comprises an optical arrangement configured to provide a measurement path of the measuring beam to the target point and an internal reference path,
the optical arrangement comprises an optics unit and a fiber connected to a source of the measuring beam, wherein the optics unit comprises:
a feed-in point for the fiber,
a beam exit for emitting the measuring beam along the target axis, and
a contacting surface configured to contact a tangential point on a surface of the datum, and
the laser tracker is configured to use the surface of the datum as a mechanical guide for a movement of the optics unit about the nodal point,
wherein:
the optics unit is embodied as mechanically fixed arrangement, and
the laser tracker comprises a force supply arrangement configured to provide a force acting on the optics unit, which causes the optics unit to maintain contact with the surface of the datum.

2. The laser tracker according to claim 1, wherein the datum is spherical and the nodal point is the center of mass of the spherical datum.

3. The laser tracker according to claim 1, wherein the contacting surface is embodied as a wear-free diamond surface, particularly a wear-free diamond plate.

4. The laser tracker according to claim 1, wherein the force supply arrangement comprises a pre-tensioned coil spring, being configured to generate a spring force acting on the optics unit and causing the optics unit to maintain contact with the surface of the datum,
Wherein:
the force supply arrangement is provided by a spring-pair mounted such that the lines of action of the springs of the spring pair are parallel to the target axis, and
the target axis is located between the lines of action, located symmetrically between the lines of action.

5. The laser tracker according to claim 1, being configured to provide magnetic attraction between the optics unit and the datum to maintain the contact with the surface of the datum.

6. The laser tracker according to claim 5, wherein the force supply arrangement is provided by:
a magnetic element arranged at the optics unit, particularly at or in the vicinity of the contacting surface, more particularly next to a contacting point on the contacting surface for contacting the tangential point, and
the datum is configured to be magnetically attractable,
wherein:
the force supply arrangement comprises at least one guide allowing an uniaxial translation of the optics unit,
the magnetic element is embodied as a permanent magnet or an electromagnet,
the datum comprises or is made from ferromagnetic material,
a direction of the uniaxial translation is parallel to the target axis, and
the magnetic element is mounted with its pole axis parallel to the target axis, or the force supply arrangement is provided by a pair of magnetic elements mounted such that the target axis is located symmetrically between the pole axes of the magnetic elements.

7. The laser tracker according to claim 5, comprising a suspension arrangement configured to provide force-free suspension of the optics unit, wherein:
the suspension arrangement is configured to support the weight of the optics unit such that a gravity-induced interaction between the contacting surface and the surface of the datum is minimized or prevented, in each relative pose of the optics unit relative to the surface of the datum.

8. The laser tracker according to claim 7, wherein the suspension arrangement comprises a tilt axis piercing a center of mass of the optics unit and thereby allows a force-free tilting of the optics unit about the tilt axis.

9. The laser tracker according to claim 8, wherein:
the tilt axis is perpendicular to and offset from the target axis, and
the tilt axis and the tangential point define a plane tangential to the surface of the datum.

10. The laser tracker according to claim 1, being configured to perform the distance measurement based on interferometric principles, in particular configured to provide the distance measurement to the target point with submicrometer precision.

11. The laser tracker according to claim 10, wherein:
the fiber is embodied as a non-polarizing single mode fiber,
the feed-in point provides an optical reference point for the internal reference path, wherein a distal end of the fiber is located outside the housing and optically coupled to a fiber splitter.

12. The laser tracker according to claim 1, wherein the optics unit comprises a first part having a first thermal expansion coefficient and a second part having a second thermal expansion coefficient, wherein:
the first thermal expansion coefficient is less than 10⁻⁵ K⁻¹, in particular less than 10⁻⁶ K⁻¹,
the second thermal expansion coefficient correlates with the thermal expansion coefficient of the datum, and
the second part is dimensioned such that its thermal expansion compensates the thermal expansion of the datum.

13. The laser tracker according to claim 1, comprising a base plate, wherein
the base plate has a fixed spatial relationship with the datum and is configured to define an orientation of the laser tracker with respect to an external coordinate system, and
the housing is rotatable relative to the base plate,
wherein:
the laser tracker comprises a support unit supporting the optics unit,
the support unit is mounted to the base plate rotatably,
the housing is mounted to the support unit, and
thermal expansion coefficients of the base plate and the support unit are selected to minimize the thermal movement of the reference point in regard to the base plate.

14. The laser tracker according to claim 13, wherein the housing
is configured to enclose the datum and the optics unit in a dust- and humidity protected manner, and
comprises a fixed exit window transparent for the measuring beam, such that for the distance measurement to the target point, the measuring beam exits at the beam exit of the optics unit and then passes the exit window.

15. The laser tracker according to claim 14, wherein the exit window:
has an extent of at least 50°, in particular at least 80°, in direction perpendicular to the plane of base plate,
is formed from chemically strengthened silicate-based glass or from sapphire-based material.

16. The laser tracker according to claim 14, further comprising a handle with fixed spatial relationship to the base plate, the laser tracker being configured to provide a transport mode, wherein a rotation of the housing is locked, and the exit window is positioned between the datum and the handle.

17. The laser tracker according to claim 12, wherein the base plate comprises:
three pads protruding from the base plate on a side opposite of the datum and providing a three-point support for the base plate, and
a plurality of drill holes configured to accommodate fastening elements providing a mechanical coupling to an external object, in particular bolts connected to corresponding sliding blocks on a measurement table,
wherein the plurality of drill holes comprises:
a first group of drill holes, wherein each of the drill holes of the first group of drill holes is located within one of the three pads, and
a second group of drill holes, wherein the second group of drill holes comprises at least one drill hole outside the three pads.

18. The laser tracker according to claim 17, wherein a plane defined by a first drill hole from the first group, a second drill hole from the second group and the nodal point is perpendicular to the plane of the base plate.
